(19) United States
(12) Patent Application Publication
(10) Pub. No.: US 2009/0029210 A1
(43) Pub. Date: Jan. 29, 2009

(54) Low-Temperature Fuel-Cell Stack and Method of Operating Same

(76) Inventors: Martin Muller, Sinzig (DE); Hendrik Dohle, Stolberg (DE); Jurgen Mergel, Julich (DE); Thorsten Wuster, Aachen (DE); Detlef Stolten, Aachen (DE)

Correspondence Address: K.F. ROSS P.C., 5683 RIVERDALE AVENUE, SUITE 203 BOX 900, BRONX, NY, 10471-0900, US

(21) Appl. No.: 11/887,815

(22) PCT Filed: Mar. 18, 2006
(86) PCT No.: PCT/DE2006/000481

§ 371 Date: Oct. 16, 2008

(30) Foreign Application Priority Data
Apr. 6, 2005 (DE) 10 2005 015 660.6

(51) Int. Cl. H01M 8/04; H01M 8/00

(52) U.S. Cl. 429/23; 429/12; 429/24

(57) ABSTRACT

The invention relates to a low-temperature fuel cell stack comprising a specific device for the supply of fuel. Said low-temperature fuel cell stack is characterised in that, in addition to the central fuel supply device, it comprises a supply or storage device for a liquid fuel, and a plurality of separately controllable dosing devices that lead into the central fuel supply device, especially respectively upstream of a distribution channel to the individual cells. Controllable valves, controllable piezoelectric pumps or thermally controllable supply elements are suitable as dosing devices. The invention also relates to a method for operating one such low-temperature fuel cell stack, which advantageously enables a defined concentration of fuel, or a defined humidity of the oxidation medium, to be adjusted at certain points in the fuel cell stack, especially on the inlet for the individual cells.

The invention relates to a low-temperature fuel-cell stack and method of operating the same.

### PRIOR ART

Prior-art fuel-cell stacks normally have a central operating-media manifold. The individual fuel cells are supplied from this feed through supply lines. The operating medium is then as a rule subsequently distributed as uniformly as possible across the surface of a membrane electrode unit (MEA) via passages in the bipolar plate or through network structures.

The prior-art devices, however, have the disadvantage that the desired uniform distribution of the operating agents across the individual cells frequently cannot be implemented satisfactorily. In particular, in water droplets formed within the cells, gas bubbles, and imprecisions in fabrication regularly result in an undersupply of the individual fuel cells. However, specifically in the case of direct-methanol fuel cells a precise and rapid control of the methanol concentration in the individual cells is required in order to maximize the efficiency and the power output.

### OBJECT AND SOLUTION

The object to be attained by the invention is to provide a method by which the adjustment of defined concentrations of methanol for individual fuel cells is possible in one stack. In addition, the object to be attained by the invention is to provide a corresponding device to implement the method.

The objects of the invention are attained by a low-temperature fuel-cell stack comprising the totality of features specified in the main claim, as well as by a method specified in the corresponding claim. Advantageous embodiments of the method and of the low-temperature fuel-cell stack are found in the respective claims related thereto.

### SUBJECT MATTER OF THE INVENTION

The invention relates to a method by which it is possible to adjust or to provide a defined concentration of fuel or water for adding humidity at certain supply points to the individual fuel cells in a low-temperature fuel-cell stack.

To this end, sensors are located a various points within the fuel-cell stack that are able to provide information on the concentration of the fuel, on the humidity of the oxidation gas, or on the cell voltage. This information functions as a controlling element for one or a plurality of dosing devices that are located at certain points of the fuel-cell stack. Suitable dosing devices include, in particular, controllable valves, controllable piezoelectric pumps, or thermally controllable feeds.

The usual means can be utilized for the dosing devices. The method of dosing can be effected, for example, in a manner analogous to a bubble-jet method, i.e. as in ink-jet printers. There are essentially two different methods here for generating an ink droplet: 1) piezoelectric pumps, or 2) pumps in which part of the ink is vaporized by a brief high application of energy, thereby driving the ink out of the nozzle head. A dosing device functioning in this manner comprising a thermally controllable feed is what is meant within the scope of this invention.

Each of the dosing devices is connected to an additional supply device or storage device that is filled with an operating medium, fuel, or oxidation medium. This supply device or storage device can be, in particular, an additional pressurized line that, for example, leads into a reservoir.

During the operation of a low-temperature fuel-cell stack, the fuel is passed through the usual central supply line to the individual cells. Sensors installed at suitable points advantageously respectively determine the specified control information, such as, i.e. the local concentrations of operating media, the humidity content of the oxidation medium, or also appropriate cell voltages for the individual cells. Whenever a sensor detects a deviation from a previously defined set-point value, this results in a controlling action by a dosing unit that is associated with this sensor and is advantageously located within the spatial proximity of the sensor. An undersupply of an operating medium, in particular fuel, which undersupply is detected at a sensor by a lower concentration relative to the set-point value, results in an activation of the corresponding dosing unit that then feeds additional fuel to this point. In the event of an excessively low humidity of the oxidation medium, water, for example, can be supplied through the dosing units.

The actual dosing can be implemented based on conventional control algorithms. What is conceivable is both a pulsed metered dosing, or, on the other hand, also a continuous metered dosing, until the sensor detects a signal that corresponds to the specified set-point value. This then stops the dosing unit. Also conceivable is control system that operates using multiple limit values instead of one specified set-point value. The dosing for fuel here is advantageously effected with concentrated fuel, i.e. in particular for a methanol-water fuel cell with highly concentrated or even pure methanol.

In addition to the usual central supply of operating media, the low-temperature fuel-cell stack according to the invention has at least one additional supply or feed device for a liquid operating medium, in particular, a liquid fuel or water. This device can, for example, be an additional supply line that is fed in particular with a more highly concentrated fuel.

The new concept for a direct fuel-cell stack provides the following technical features:

the fuel-cell stack has at least one additional interior chamber to store a liquid operating agent, in particular, an additional supply or storage device for a liquid operating medium;

the liquid operating media are, in particular, methanol, a highly concentrated methanol solution, or also water;

the interior chamber is connected at multiple points to the dosing devices;

the dosing devices lead to a supply line that feeds an operating medium to the individual cells;

the dosing devices are separately controllable;

the dosing devices are, in particular, piezoelectric pumps, or thermally controlled feed, or analogously controlled valves;

the valves or pumps are controlled by a controller that collects information on the load or operating states of the individual cells.

These fundamental technical features advantageously enable the concentrations of operating media to be locally adjusted for the supply to the individual fuel cells.

The afore-mentioned design of the low-temperature fuel-cell stack can be employed both on the anode side for dosing the fuel and also advantageously on the cathode side, where water is then advantageously used as the liquid medium for humidifying purposes.

### SPECIFIC DESCRIPTION

The following discussion describes the subject matter of the invention in more detail based on figures, without the subject matter of the invention's being limited thereby.

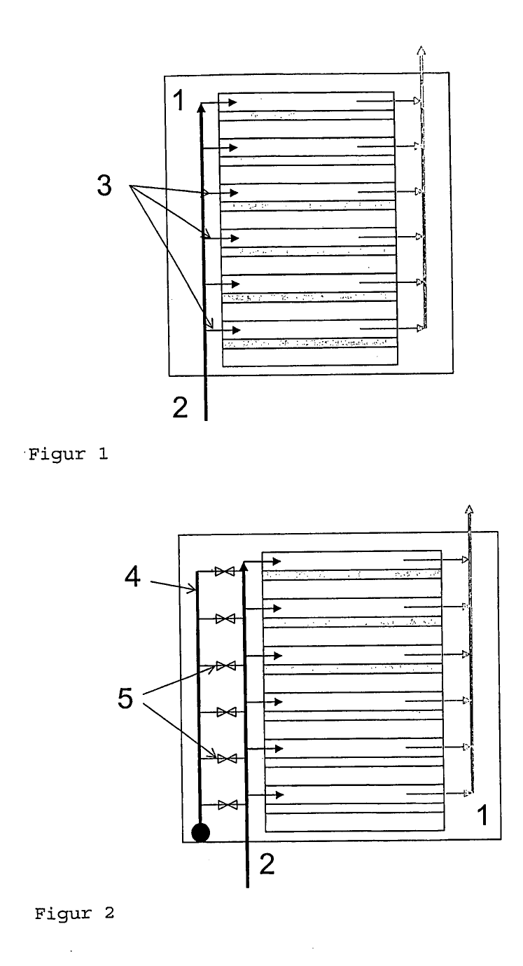

FIG. 1 shows the prior art for the distribution of an operating medium to the individual fuel cells in a fuel-cell stack 1. The distribution of the operating media is indicated by individual arrows. The operating medium, for example fuel, first passes through a central operating-media manifold 2 that then branches off into the individual distribution passages 3 to the individual cells. The corresponding discharge from the individual cells and the fuel-cell stack is indicated in gray.

In contrast thereto, FIG. 2 shows the improvement of the adjustment of the local concentration of the operating medium through the additional feed of an operating medium, in particular, of a highly concentrated operating medium such as, for example, pure methanol, through the dosing devices 5. The dosing devices are connected to one or a plurality of additional supply devices or storage devices 4 for a liquid operating medium, and are supplied with the operating medium through these. The supply device or storage device can, for example, be another passage and/or also a cavity (reservoir) located in the plate. The dosing devices advantageously open near the junctions with the distribution passages into the central manifold, or even directly into this feed, with the result that the desired concentration can be adjusted for a fuel cell or for a cell package in a targeted manner.

Suitably installed sensors enable a highly precise control or regulation of the supply of an operating medium to be effected as long as the sensor information is provided to the individually controllable dosing devices.

1. A low-temperature fuel-cell stack comprising a central operating-media manifold for the individual cells wherein
the fuel-cell stack has an additional supply device or storage device for a liquid operating medium, and
the fuel-cell stack comprises a plurality of separately controllable dosing devices that are connected to the additional supply device or storage device and lead into the central operating-media manifold.

2. The low-temperature fuel-cell stack according to claim 1 wherein at least one controllable valve, one controllable piezoelectric pump, or one thermally controllable feed serves as the dosing device.

3. The low-temperature fuel cell according to claim 1 wherein the dosing devices each open into the operating-media manifold at the point at which distribution to the individual cells is effected.

4. The low-temperature fuel-cell stack according to claim 1, further comprising
a supply device or storage device for supplying methanol or a highly concentrated methanol solution.

5. The low-temperature fuel-cell stack according to claim 1, further comprising
a supply device or storage device for supplying water.

6. The low-temperature fuel-cell stack according to claim 1 wherein the dosing devices are connected to sensors.

7. The low-temperature fuel-cell stack according to claim 6 wherein the sensors are able to measure the concentration of an operating medium and/or the humidity of an oxidation medium and/or the cell voltage and/or the temperature.

8. The low-temperature fuel-cell stack according to claim 6 wherein the sensors serve as a control device for the dosing devices.

9. The low-temperature fuel-cell stack according to claim 6 wherein each sensor and the respective dosing device controlled by this sensor are located near one another.

10. A method of operating a low-temperature fuel-cell stack according to claim 1 wherein an operating medium is supplied through the separately controllable dosing devices to at least one single fuel cell in a targeted manner.

11. The method according to claim 10 wherein an operating medium is supplied through a dosing device to every single fuel cell in a targeted manner.

12. The method according to claim 10 wherein methanol or a highly concentrated methanol solution is supplied.

13. The method according to claims 10 wherein the separately controllable dosing devices are controlled by sensors able to measure the concentration of an operating medium and/or the humidity of an oxidation medium and/or the cell voltage and/or the temperature.

14. The method according to claim 10 wherein each dosing device is controlled separately through a respective adjacent sensor.
